(19) United States
(12) Patent Application Publication
(10) Pub. No.: US 2025/0026616 A1
(43) Pub. Date: Jan. 23, 2025

(54) RIGGING TABLE

(71) Applicant: James L. Schadler, Birdsboro, PA (US)

(72) Inventor: James L. Schadler, Birdsboro, PA (US)

(21) Appl. No.: 18/779,196

(22) Filed: Jul. 22, 2024

Related U.S. Application Data
(60) Provisional application No. 63/514,835, filed on Jul. 21, 2023.

(51) Int. Cl. B66C 13/08; B66C 1/12

(52) U.S. Cl. CPC B66C 13/08; B66C 1/122

(57) ABSTRACT

A rigging table and methods of using the same are disclosed. The rigging table includes adjustable features to assist with rigging. The rigging table may be utilized in servicing industrial machines. The industrial machines may be, for example, injection molding machines. The rigging table may allow removing the injection molding machine motor and gearbox, which may be approximately 6,000 Lb., servicing and/or rebuilding the same on the rigging table, and reinstalling the same into machine.

### CROSS-REFERENCE TO RELATED APPLICATIONS

This application claims the benefit of U.S. Provisional Application Ser. No. 63/514,835 filed on Jul. 21, 2023, which is incorporated by reference herein in its entirety.

### FIELD

This disclosure relates to rigging tables capable of supporting workpieces of substantial weight while being able to adjust the positioning of the workpiece on the rigging table, and move the rigging table from one location to another.

### BACKGROUND

Servicing of large scale industrial machines often requires removal of massive portions of the machine. The standard rigging mechanism for carrying the weight of these portions is the use of a crane. Once removed, the portion, or workpiece, must be supported during work.

Cranes are, however, not an option in many crowded settings. For example, modern injection molding machines are often deployed with several in a relatively confined space with roofing overhead. As such cranes cannot be moved between the machines nor can a crane approach through the closed roof.

A need exists to provide a device and method enabling removal and support of massive workpieces. A need also exists to provide an improved method of servicing industrial machines; e.g., Husky injection molding machines.

### SUMMARY

In accordance with one aspect of the present disclosure, a rigging table comprises an upper plate, a lower plate, vertical supports, secondary vertical supports, horizontal supports, at least one floating rail, at least one support bracket, and at least one coarse threaded rod. The vertical supports support and are fixed to the lower plate. The secondary vertical supports are positioned on the lower plate and support the upper plate. The secondary vertical supports are fixed to at least one of the lower plate or the upper plate. The secondary vertical supports are adjustable in height in order to adjust the height of the upper plate. The at least one floating rail is positioned on an upper surface of the upper plate. The at least one support bracket is slidingly engaged with the floating rail.

The at least one floating rail can include at least two floating rails extending parallel to one another such that a workpiece may be positioned between them. Each floating rail can include two support brackets slidingly engaged thereon. The at least one support bracket can be reversibly fixable to a workpiece positioned on the upper plate. A position of a workpiece can be adjusted up or down via adjustment of the secondary supports. A position of a workpiece can be adjusted horizontally by movement of the at least one support bracket along the at least one floating rail. At least one support bracket can be reversibly fixable in position such that a workpiece on the upper plate is horizontally stabilized. The vertical supports can be supported for movement over a surface by at least one of skates, wheels, rails, or skis, to enable movement of the rigging table. The at least one of skates, wheels, rails or skis can be lockable in order to prevent movement of the rigging table. The rigging table can include at least one tertiary vertical support between the upper plate and the lower plate. The upper plate and the lower plate can include receivers for the at least one tertiary vertical support. The at least one tertiary support can include a coarse threaded rod received in the receivers of the upper and lower plate. The rigging table can include quaternary supports engaged with the tertiary supports and configured to inhibit downward movement of the upper plate should the secondary supports drift. At least one of the secondary vertical supports can include a hydraulic jack.

In accordance with another aspect, a rigging table comprises four bearing skates, four vertical supports, four horizontal supports, a lower plate, four corner hydraulic jacks, an upper plate, a floating hydraulic jack, four coarse threaded rods, and four stabilizing nuts, each of the vertical supports having a first end, a second end, a first horizontal support interface surface proximal to the second end, and a second horizontal support interface surface proximal to the second end each bearing skate fixed to the first end of one of the vertical supports, the lower plate comprising four lower plate corners, a lower plate top, a lower plate bottom, a lower plate center, and four coarse threaded rod lower receivers, each second end of the vertical supports fixed to the lower plate bottom at a respective one of the four lower plate corners, each of the horizontal supports comprising a first end, a second end, and an upper surface extending between a respective pair of the four vertical supports and along the bottom of the lower plate, each of the four corner jacks comprising a base and a saddle, and the respective base of each positioned at a respective one of the four corners of the lower plate and on the lower plate top, the upper plate comprising a first side, a second side, a third side, a fourth side, four upper plate corners, an upper plate top, an upper plate bottom, an upper plate center, two floating rails, four support brackets, and four coarse threaded rod upper receivers, the respective saddle of each of the hydraulic jacks fixed to the upper plate bottom at a respective one of the four upper plate corners, a first of the two floating rails extending along the upper plate top proximal and parallel to the first side, a second of the two floating rails extending along the upper plate top proximal and parallel to the third side, a first two of the four support brackets slidingly engaged with the first of the two floating rails, a second two of the four support brackets slidingly engaged with the second of the two floating rails, each support bracket configured to engage a workpiece positioned on the upper plate top, a first two of the four coarse threaded rod upper receivers positioned proximal to the second side, a second two of the four coarse threaded rod upper receivers positioned proximal to the fourth side, each respective one of the four coarse threaded rod upper receivers position above and in line with a respective one of the four coarse threaded rod lower receivers, the floating jack comprising a base and a saddle and configured to be positioned at a positioned at a point between the lower plate and upper plate, preferably between the lower plate center and the upper plate center, with base on the lower plate top and the saddle on the upper plate bottom, each one of the four coarse threaded rods threadingly engaged in a respective one of the coarse threaded rod upper receivers and the coarse threaded lower receiver in line thereof, each one of the four stabilizing nuts threadingly engaged with a respective one of the four coarse threaded rods, positioned between the lower plate and the upper plate, and configured to engage the upper plate bottom.

In an embodiment, the first end of a first of the horizontal supports is fixed to the first horizontal support interface of a first of the vertical supports, the second end of the first of the horizontal supports fixed to the second horizontal support interface surface of a second of the vertical supports, the first end of a second of the horizontal supports fixed to the first horizontal support interface surface of the second of the vertical supports, the second end of the second of the horizontal supports fixed to the second horizontal support interface of a third of the vertical supports, the first end of a third of the horizontal supports fixed to the first horizontal support interface surface of the third of the vertical supports, the second end of the third of the horizontal supports fixed to the second horizontal support interface of a fourth of the vertical supports, the first end of a fourth of the horizontal supports fixed to the first horizontal support interface surface of the fourth of the vertical supports, the second end of the fourth of the horizontal supports fixed to the second horizontal support interface of the first of the vertical supports;

In accordance with another aspect of the present disclosure, a method of servicing a large scale machine comprises positioning a rigging table proximal to a component of the machine, the rigging table including: four bearing skates, four vertical supports, four horizontal supports, a lower plate, four corner hydraulic jacks, an upper plate, a floating hydraulic jack, four coarse threaded rods, and four stabilizing nuts, each of the vertical supports having a first end, a second end, a first horizontal support interface surface proximal to the second end, and a second horizontal support interface surface proximal to the second end each bearing skate fixed to the first end of one of the vertical supports, the lower plate comprising four lower plate corners, a lower plate top, a lower plate bottom, a lower plate center, and four coarse threaded rod lower receivers, each second end of the vertical supports fixed to the lower plate bottom at a respective one of the four lower plate corners, each of the horizontal supports comprising a first end, a second end, and an upper surface extending between a respective pair of the four vertical supports and along the bottom of the lower plate;

each of the four corner jacks comprising a base and a saddle, and the respective base of each positioned at a respective one of the four corners of the lower plate and on the lower plate top, the upper plate comprising a first side, a second side, a third side, a fourth side, four upper plate corners, an upper plate top, an upper plate bottom, an upper plate center, two floating rails, four support brackets, and four coarse threaded rod upper receivers, the respective saddle of each of the hydraulic jacks fixed to the upper plate bottom at a respective one of the four upper plate corners, a first of the two floating rails extending along the upper plate top proximal and parallel to the first side, a second of the two floating rails extending along the upper plate top proximal and parallel to the third side, a first two of the four support brackets slidingly engaged with the first of the two floating rails, a second two of the four support brackets slidingly engaged with the second of the two floating rails, each support bracket configured to engage a workpiece positioned on the upper plate top, a first two of the four coarse threaded rod upper receivers positioned proximal to the second side, a second two of the four coarse threaded rod upper receivers positioned proximal to the fourth side, each respective one of the four coarse threaded rod upper receivers position above and in line with a respective one of the four coarse threaded rod lower receivers, the floating jack comprising a base and a saddle and configured to be positioned at a positioned at a point between the lower plate and upper plate, preferably between the lower plate center and the upper plate center, with base on the lower plate top and the saddle on the upper plate bottom, each one of the four coarse threaded rods threadingly engaged in a respective one of the coarse threaded rod upper receivers and the coarse threaded lower receiver in line thereof, each one of the four stabilizing nuts threadingly engaged with a respective one of the four coarse threaded rods, positioned between the lower plate and the upper plate, and configured to engage the upper plate bottom, adjusting the height of upper plate to support the component, disengaging the component from the machine, positioning the rigging table in a location where servicing of the component will take place, servicing the component, repositioning the rigging table proximal to the location where the component attaches to the machine, re-engaging the component with the machine.

The position can include either leaving the rigging table in place, or moving it to a second site. The machine can be an injection molding machine comprising a motor and gearbox and the component can be the motor and gearbox. The injection molding machine can be a Husky machine.

### BRIEF DESCRIPTION OF THE DRAWING

The following detailed description of embodiments of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a perspective view of an exemplary rigging table in accordance with the present disclosure.

FIG. 2 is an enlarged portion of FIG. 1

### DETAILED DESCRIPTION OF EMBODIMENTS

Certain terminology is used in the following description for convenience only and is not limiting. The words “right,” “left,” “top,” and “bottom” designate directions in the drawings to which reference is made.

The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

As used herein the term “fixed” may be any means of attaching one element to another in order to endure the burden of the rigging table components and the intended workpiece. Fixed may mean welded. “Reversibly fixed” means that the elements so fixed may be fastened one to another, but that the fastener may be released in order to disengage the components.

An embodiment includes an adjustable table to assist with rigging. The rigging table may be utilized in servicing industrial machines. The industrial machines may be, for example, injection molding machines. The rigging table may allow removing the injection molding machine motor and gearbox, which may be approximately 6,000 Lb., servicing and/or rebuilding the same on the rigging table, and reinstalling the same into machine. The injection molding machine may be a Husky machine.

Although injection molding machines, including Husky machines, are described as examples, a rigging table of an embodiment herein may be implemented in servicing other machines with similarly massive component(s). The rigging table may allow removing the massive component(s), servicing and/or rebuilding the same on the rigging table, and reinstalling the same into machine.

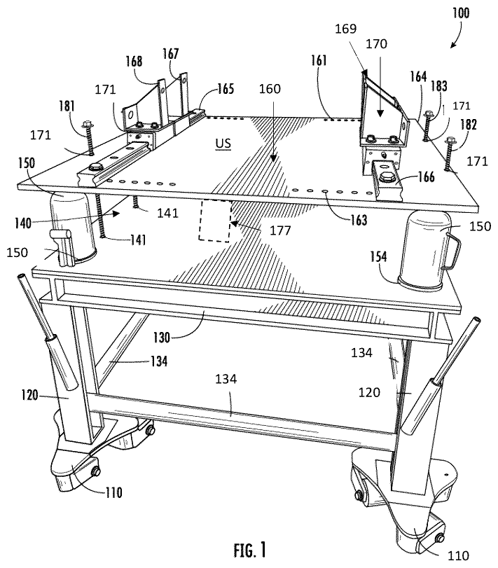

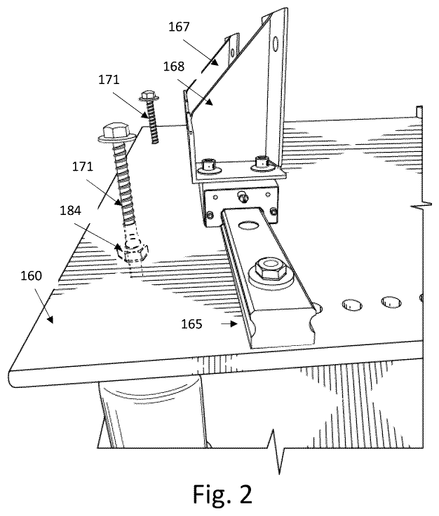

Referring to FIG. 1, an embodiment includes a rigging table 100. The rigging table 100 comprising four bearing skates 110 (only two bearing skates visible in FIG. 1), four vertical supports 120 (only two vertical supports visible in FIG. 1, four horizontal supports 130 (only one horizontal support shown in FIG. 1), a lower plate 140, four corner hydraulic jacks 150 (only two hydraulic jacks visible in FIG. 1), an upper plate 160, a floating hydraulic jack 177 (shown schematically), four coarse threaded rods 180, 181, 182, and 183, and four stabilizing nuts 184 (see FIG. 2) engaged with a respective one of the rods. The rigging table 100 may also comprise four braces 134 (only three braces visible in FIG. 1.

Each of the vertical supports 120 has a first end illustrated in FIG. 1 next to the respective bearing skate. For each vertical support 120, a bearing skate 110 of the four bearing skates is fixed to the first end of one of the respective vertical support 120. The bearing skates 110 may allow positioning of the rigging table 100 with or without the load of a workpiece. The bearing skates 110 may lock in order to inhibit movement of the rigging table 100. Each of the vertical supports 120 also has a second end proximal to and fixed to the lower plate 140.

Each of the vertical supports 120 also includes a first horizontal support interface surface proximal to the second end, and a second horizontal support interface surface also proximal to the second end. A horizontal support interface surface is a region where one of the horizontal supports 130 is fixed to a respective vertical support 120. One or more of the horizontal supports 130 may be removably fixed and/or adjustable.

As illustrated in FIG. 1, the lower plate 140 comprises four lower plate corners, a lower plate top, a lower plate bottom, a lower plate center, and four coarse threaded rod lower receivers 141 (only two lower receivers visible in FIG. 1). Each second end of the vertical supports 120 is fixed to the lower plate bottom at a respective one of the four lower plate corners.

Each of the horizontal supports 130 comprises a first end, a second end, and an upper surface extending between a respective pair of the four vertical supports 120 (e.g., along a side of the rigging table 100) and along the bottom of the lower plate 140. One or more of the horizontal supports 130 may be fixed to the lower plate 140. The first end of each horizontal support 130 is fixed to one of the vertical supports 120 at the horizontal support interface of the vertical support 120. The second end of each horizontal support 130 is fixed to a neighboring one of the vertical supports 120.

The vertical supports 120 may be numbered as a first, second, third, and fourth vertical support, respectively, each corresponding to a respective one of the four corners of the rigging table 100. The horizontal supports 130 may be numbered as a first, second, third, and fourth horizontal support, respectively, corresponding to respective one of the four sides of the rigging table 100.

As illustrated in FIG. 1, the first end of the first horizontal support 130 is fixed to the first horizontal support interface of the first vertical support 120. The second end of the first horizontal support 130 is fixed to the second horizontal support interface surface of the second vertical support 120.

The first end of the second horizontal support 130 is fixed to the first horizontal support interface surface of the second vertical support 120. The second end of the second horizontal support 130 is fixed to the second horizontal support interface of the third vertical support 120.

The first end of the third of the horizontal support 130 is fixed to the first horizontal support interface surface of the third vertical support 120. The second end of the third horizontal support 130 is fixed to the second horizontal support interface of the fourth vertical support 120.

The first end of the fourth horizontal support 130 is fixed to the first horizontal support interface surface of the fourth vertical support 120. The second end of the fourth horizontal support 130 is fixed to the second horizontal support interface of the first vertical support 120.

Braces 134 similarly run from vertical support to vertical support and each end of the braces 134 (not shown) are also fixed the respective vertical support it contacts.

Each of the four corner jacks 150 (secondary supports) comprises a base 154 and a saddle (not visible in the figures), and the respective base of each positioned at a respective one of the four corners of the lower plate and on the lower plate top. The base 154 of one or more of the four corner jacks 150 may be fixed to the lower plate 140. The saddle of one or more of the four corner jacks 150 may be fixed to the upper plate 160. The corner jacks 150 may be adjustable in height in order to adjust the height of the upper plate 160, and support the upper plate 160 at height with a workpiece thereon.

The upper plate 160 is generally rectangular comprises first, second, third and fourth sides 161, four upper plate corners, an upper plate top, an upper plate bottom, an upper plate center, two floating rails 165, 166, four support brackets 167, 168, 169, 170, and four coarse threaded rod upper receivers 171. The respective saddle of each of the hydraulic jacks is fixed to the upper plate bottom at a respective one of the four upper plate corners. A first of the two floating rails 165/166 extends along the upper plate top proximal and parallel to a first side 161. A second of the two floating rails 165/166 extends along the upper plate top proximal and parallel to a second side 161 opposite the first side 161. A floating rail can comprise a bar bolted to the upper plate 160. The bar may be steel. A floating rail may have bolt holes through which bolts extend. The upper plate 160 may include bolt holes 163 through which floating rail bolts may extend. A series of bolt holes 163 on the upper plate 160 may allow repositioning of a floating rail. The support brackets 167, 168 are slidingly engaged with the floating rail 165. The support brackets 169, 170 are slidingly engaged with the floating rail 166. Each support bracket can be configured to engage a workpiece positioned on the upper plate top. The support brackets may allow horizontal adjustment of the workpiece. The support brackets may be reversibly fixed to the respective floating rail to horizontally stabilize the workpiece. The support brackets 167, 168, 169, 170 may include a base configured to attached to the respective floating to which they are attached. A support bracket base may include bearings allowing the bracket to slide along the floating rail to which it is mounted. A support bracket base may be lockable in a single position along the floating rail to which it is mounted. The means to lock a support bracket in place may include bolts. In such a configuration, the brackets can be unbolted and slide in or out on the steel bar (floating rail) and rebolted to accommodate different sizes of machines. The bar (floating rail) itself may also be unbolted and slide in or out to secure the machine in position.

A rigging table may comprise four different sizes of support brackets. The rigging table may also comprise a tool kit. A rigging table may comprise 4″, 8″, 10″ and 12″ support brackets. The support brackets may mount to a motor (e.g., a workpiece) to assist getting the motor from its original place and onto the rigging table such that the motor can be secured and worked upon. A Husky motor has bolt holes in it and can be bolted to the support brackets.

Two coarse threaded rod upper receivers 171 are positioned proximal to respective opposite sides 161 of the upper plate 160. The coarse threaded rod upper receivers 171 are positioned above and in line with coarse threaded rod lower receivers 141. In this configuration, each coarse threaded rod 180/181/182/183 (tertiary supports) may engage both a respective coarse threaded rod upper receiver 171 and a respective coarse threaded rod lower receiver 141. As shown, each one of the four coarse threaded rods 180/181/182/183 threadingly engaged in a respective one of the coarse threaded rod upper receivers and the coarse threaded lower receiver in line thereof. Each one of the four stabilizing nuts (quaternary supports) 184 threadingly engaged with a respective one of the four coarse threaded rods, and is positioned between the lower plate 140 and the upper plate 160. The stabilizing nuts 184 are configured to engage the upper plate bottom. In this configuration they may act as a stop if one or more of the hydraulic jacks drift, or may set a minimum height of the upper plater 160. The coarse threaded rods 180, 181, 182, and 183 may be removable and adjustable.

The floating jack 177 comprises a base and a saddle and is configured to be positioned at a point between the lower plate 140 and upper plate 160, with base on the lower plate top and the saddle on the upper plate bottom. Preferably the floating jack is positioned between the lower plate center and the upper plate center, with base on the lower plate top and the saddle on the upper plate bottom. The floating jack may be adjustable in height in order to adjust the height of the upper plate 160, and support the upper plate at height and with a workpiece thereon.

In an embodiment, a rigging table herein comprises an upper plate, a lower plate, vertical supports, secondary vertical supports, horizontal supports, at least one floating rail, and at least one support bracket. The rigging table may also comprise at least one coarse threaded rod. The vertical supports may support and may be fixed the lower plate. The secondary vertical supports may be positioned on the lower plate and support the upper plate. The secondary vertical supports may be fixed to one or both of the lower plate and the upper plate. The secondary vertical supports may be adjustable in height in order to adjust the height of the upper plate. One or more of the secondary vertical supports may be a hydraulic jack. The at least one floating rail is position on an upper surface US of the upper plate. One or more of the at least one support bracket is slidingly engaged with the floating rail. Preferably there are at least two floating rails and two of the them are parallel to one anther such that a workpiece may be positioned between them. Preferably, two support brackets are slidingly engaged on each of the two preferred floating rails. The at least one support bracket may be reversibly fixed to a workpiece positioned on the upper plate. Preferably, the workpiece may be adjusted up or down via adjustment of the secondary supports. Preferably the workpiece may be adjusted horizontally by movement of the support brackets along the floating rails. Preferably, the support brackets may be reversibly fixed in position such that the workpiece is horizontally stabilized. The vertical supports may include skates, wheels, rails, skis, or other movement means to enable movement of the rigging table. These movement means may be lockable in order to prevent movement of the rigging table. The rigging table may include one or more tertiary vertical supports between the upper plate and the lower plate. The upper plate and the lower plate may comprise receivers for the tertiary vertical supports. The combination of a tertiary vertical support and its respective receivers may be as described with respect to FIG. 1 for a coarse threaded rod and its receivers. The rigging table may comprise quaternary supports engaged with the tertiary supports and configured to inhibit downward movement of the upper plate should the secondary supports drift.

A skate herein may be a Lb. 16,0000 Skates. The choice of skate size may be made based on size and weight of the table, and the weight it will support.

An upper plate herein may be a one inch carbon steel AR plate. Preferably, the upper plate is 1″ thick carbon steel. The plate may comprise, consist essentially of, or consist of cold rolled carbon steel. An upper plate may be 4′×4′×1″.

A vertical support herein may be an iron beam The iron beam may be a 4×4 inch I beam.

A brace herein may be a 2½ inch pipe as a spreader. A brace may be a 40 black iron pipe. A brace may be welded to the flat side of the beams.

A skate herein may be a 16,000 Lb. bearing skates with a ½ inch plate on top of the plate. A skate may be fixed; preferably welded, to its respective vertical support. A skate herein may have three or more wheels.

A hydraulic jack herein may be a 20 ton hydraulic jack. Larger cylinder at top of jack support table.

A secondary support herein may be a 20 ton hydraulic jacks.

A coarse threaded rod herein may act as a stop if weight is left on a rigging table for length of time. A stabilizing nut or quaternary support with a plate welded to it may be positioned below table. The stabilizing nut or quaternary support may be adjusted to engage the bottom of the upper plate to act as a stop to jack drift. A coarse threaded rod may be ¾ inch in diameter.

Preferably a jack herein in the closed position is at 8 inches and has a maximum height of 10 inches.

A floating rail herein may be on a bearing slide. Preferably each slide may endure the burden of 10,000 Lbs. A floating rail may have dimensions of 1.5×2 inch.

A horizontal support herein may be a 4″×4″ I beam. A horizontal support herein may be steel.

Preferably, from floor to a rigging table top (upper plate top) is 52 inches in a closed position, and 54 inches in an open position.

A support bracket herein may include a bolt hole through which a bolt may be threaded into the workpiece. The support brackets on one floating rail may be 10 inches apart such as found on larger injection molding machine motors and gear boxes. The support brackets on one floating rail may be 6 inches apart such as found on smaller injection molding machine motors and gear boxes. The support brackets may be adjusted along the floating rail. A support bracket may be a 3×5 angle iron support bracket.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A rigging table comprising an upper plate, a lower plate, vertical supports, secondary vertical supports, horizontal supports, at least one floating rail, at least one support bracket, and at least one coarse threaded rod;
the vertical supports support and are fixed to the lower plate;
the secondary vertical supports are positioned on the lower plate and support the upper plate;
the secondary vertical supports are fixed to at least one of the lower plate or the upper plate;
the secondary vertical supports are adjustable in height in order to adjust the height of the upper plate;
the at least one floating rail is positioned on an upper surface of the upper plate; and
the at least one support bracket is slidingly engaged with the floating rail.

2. The rigging table of claim 1, wherein the at least one floating rail comprises at least two floating rails extending parallel to one another such that a workpiece may be positioned between them.

3. The rigging table of claim 2, wherein each floating rail includes two support brackets slidingly engaged thereon.

4. The rigging table of claim 1, wherein the at least one support bracket is reversibly fixable to a workpiece positioned on the upper plate.

5. The rigging table of claim 1, wherein a position of a workpiece can be adjusted up or down via adjustment of the secondary supports.

6. The rigging table of claim 1, wherein a position of a workpiece can be adjusted horizontally by movement of the at least one support bracket along the at least one floating rail.

7. The rigging table of claim 1, wherein the at least one support bracket is reversibly fixable in position such that a workpiece on the upper plate is horizontally stabilized.

8. The rigging table of claim 1, wherein the vertical supports are supported for movement over a surface by at least one of skates, wheels, rails, or skis, to enable movement of the rigging table.

9. The rigging table of claim 8, wherein the at least one of skates, wheels, rails or skis are lockable in order to prevent movement of the rigging table.

10. The rigging table of claim 1, wherein the rigging table includes at least one tertiary vertical support between the upper plate and the lower plate.

11. The rigging table of claim 10, wherein the upper plate and the lower plate comprise receivers for the at least one tertiary vertical support.

12. The rigging table of claim 11, wherein the at least one tertiary support includes a coarse threaded rod received in the receivers of the upper and lower plate.

13. The rigging table of claim 1, wherein the rigging table comprises quaternary supports engaged with the tertiary supports and configured to inhibit downward movement of the upper plate should the secondary supports drift.

14. The rigging table of claim 1, wherein at least one of the secondary vertical supports is a hydraulic jack.

15. A rigging table comprising:
four bearing skates, four vertical supports, four horizontal supports, a lower plate, four corner hydraulic jacks, an upper plate, a floating hydraulic jack, four coarse threaded rods, and four stabilizing nuts;
each of the vertical supports having a first end, a second end, a first horizontal support interface surface proximal to the second end, and a second horizontal support interface surface proximal to the second end each bearing skate fixed to the first end of one of the vertical supports;
the lower plate comprising four lower plate corners, a lower plate top, a lower plate bottom, a lower plate center, and four coarse threaded rod lower receivers, each second end of the vertical supports fixed to the lower plate bottom at a respective one of the four lower plate corners;
each of the horizontal supports comprising a first end, a second end, and an upper surface extending between a respective pair of the four vertical supports and along the bottom of the lower plate;
each of the four corner jacks comprising a base and a saddle, and the respective base of each positioned at a respective one of the four corners of the lower plate and on the lower plate top;
the upper plate comprising a first side, a second side, a third side, a fourth side, four upper plate corners, an upper plate top, an upper plate bottom, an upper plate center, two floating rails, four support brackets, and four coarse threaded rod upper receivers,
the respective saddle of each of the hydraulic jacks fixed to the upper plate bottom at a respective one of the four upper plate corners,
a first of the two floating rails extending along the upper plate top proximal and parallel to the first side, a second of the two floating rails extending along the upper plate top proximal and parallel to the third side;
a first two of the four support brackets slidingly engaged with the first of the two floating rails, a second two of the four support brackets slidingly engaged with the second of the two floating rails, each support bracket configured to engage a workpiece positioned on the upper plate top,
a first two of the four coarse threaded rod upper receivers positioned proximal to the second side, a second two of the four coarse threaded rod upper receivers positioned proximal to the fourth side, each respective one of the four coarse threaded rod upper receivers position above and in line with a respective one of the four coarse threaded rod lower receivers;
the floating jack comprising a base and a saddle and configured to be positioned at a positioned at a point between the lower plate and upper plate, preferably between the lower plate center and the upper plate center, with base on the lower plate top and the saddle on the upper plate bottom;
each one of the four coarse threaded rods threadingly engaged in a respective one of the coarse threaded rod upper receivers and the coarse threaded lower receiver in line thereof,
each one of the four stabilizing nuts threadingly engaged with a respective one of the four coarse threaded rods, positioned between the lower plate and the upper plate, and configured to engage the upper plate bottom.

16. The rigging table of claim 15, wherein
the first end of a first of the horizontal supports fixed to the first horizontal support interface of a first of the vertical supports, the second end of the first of the horizontal supports fixed to the second horizontal support interface surface of a second of the vertical supports,
the first end of a second of the horizontal supports fixed to the first horizontal support interface surface of the second of the vertical supports, the second end of the second of the horizontal supports fixed to the second horizontal support interface of a third of the vertical supports,
the first end of a third of the horizontal supports fixed to the first horizontal support interface surface of the third of the vertical supports, the second end of the third of the horizontal supports fixed to the second horizontal support interface of a fourth of the vertical supports,
the first end of a fourth of the horizontal supports fixed to the first horizontal support interface surface of the fourth of the vertical supports, the second end of the fourth of the horizontal supports fixed to the second horizontal support interface of the first of the vertical supports;

17. A method of servicing a large scale machine comprising:
positioning a rigging table proximal to a component of the machine, the rigging table including:
four bearing skates, four vertical supports, four horizontal supports, a lower plate, four corner hydraulic jacks, an upper plate, a floating hydraulic jack, four coarse threaded rods, and four stabilizing nuts;
each of the vertical supports having a first end, a second end, a first horizontal support interface surface proximal to the second end, and a second horizontal support interface surface proximal to the second end each bearing skate fixed to the first end of one of the vertical supports;
the lower plate comprising four lower plate corners, a lower plate top, a lower plate bottom, a lower plate center, and four coarse threaded rod lower receivers, each second end of the vertical supports fixed to the lower plate bottom at a respective one of the four lower plate corners;
each of the horizontal supports comprising a first end, a second end, and an upper surface extending between a respective pair of the four vertical supports and along the bottom of the lower plate;
each of the four corner jacks comprising a base and a saddle, and the respective base of each positioned at a respective one of the four corners of the lower plate and on the lower plate top;
the upper plate comprising a first side, a second side, a third side, a fourth side, four upper plate corners, an upper plate top, an upper plate bottom, an upper plate center, two floating rails, four support brackets, and four coarse threaded rod upper receivers,
the respective saddle of each of the hydraulic jacks fixed to the upper plate bottom at a respective one of the four upper plate corners,
a first of the two floating rails extending along the upper plate top proximal and parallel to the first side, a second of the two floating rails extending along the upper plate top proximal and parallel to the third side;
a first two of the four support brackets slidingly engaged with the first of the two floating rails, a second two of the four support brackets slidingly engaged with the second of the two floating rails, each support bracket configured to engage a workpiece positioned on the upper plate top,
a first two of the four coarse threaded rod upper receivers positioned proximal to the second side, a second two of the four coarse threaded rod upper receivers positioned proximal to the fourth side, each respective one of the four coarse threaded rod upper receivers position above and in line with a respective one of the four coarse threaded rod lower receivers;
the floating jack comprising a base and a saddle and configured to be positioned at a positioned at a point between the lower plate and upper plate, preferably between the lower plate center and the upper plate center, with base on the lower plate top and the saddle on the upper plate bottom;
each one of the four coarse threaded rods threadingly engaged in a respective one of the coarse threaded rod upper receivers and the coarse threaded lower receiver in line thereof,
each one of the four stabilizing nuts threadingly engaged with a respective one of the four coarse threaded rods, positioned between the lower plate and the upper plate, and configured to engage the upper plate bottom;
adjusting the height of upper plate to support the component;
disengaging the component from the machine;
positioning the rigging table in a location where servicing of the component will take place;
servicing the component;
repositioning the rigging table proximal to the location where the component attaches to the machine;
re-engaging the component with the machine.

18. The method of claim 17, where the position comprises either leaving the rigging table in place, or moving it to a second site.

19. The method of claim 17, wherein the machine is an injection molding machine comprising a motor and gearbox and the component is the motor and gearbox.

20. The method of claim 19, wherein the injection molding machine is a Husky machine.
